(19) United States
(12) Patent Application Publication
(10) Pub. No.: US 2017/0220870 A1
(43) Pub. Date: Aug. 3, 2017

(54) METHOD AND SYSTEM FOR ANALYZING OCCUPANCY IN A SPACE

(71) Applicant: POINTGRAB LTD., Hod Hasharon (IL)

(72) Inventors: ITAMAR ROTH, TEL-AVIV (IL); HAIM PERSKI, HOD HASHARON (IL)

(21) Appl. No.: 15/293,310

(22) Filed: Oct. 14, 2016

Related U.S. Application Data
(60) Provisional application No. 62/287,913, filed on Jan. 28, 2016.

(51) Int. Cl. G06K 9/00; G06T 7/00

(52) U.S. Cl. CPC G06K 9/00771; G06T 7/0081; G06T 2207/10004

(57) ABSTRACT

A method and system are provided for analyzing occupancy in a space by automatically identifying a region of interest in the space based on image analysis and enabling different outputs based on detection of occupancy in the region of interest or outside it.

### CROSS-REFERENCE TO RELATED APPLICATIONS

This application claims the benefit of priority from U.S. Provisional Patent Application No. 62/287,913, filed Jan. 28, 2016, the contents of which are incorporated herein by reference in their entirety.

### FIELD

The present invention relates to analyzing occupancy in a space. Specifically, the invention relates to automatic analysis of occupancy in a space based on image analysis.

### BACKGROUND

The ability to detect and monitor occupancy in a space, such as a room or building, enables planning and controlling building systems for better space utilization, to minimize energy use, for security systems and more.

The use of sensors to detect and monitor occupancy in spaces has been explored. For example, image sensors are sometimes used to detect occupancy in a space, typically by detecting motion in images of the space. To help optimize operation of the image sensor the space may be partitioned into regions, such that movement detected in specific regions can be positively identified as an occupant in the space whereas movement in other regions may be ignored.

Partitioning of the space typically requires prior knowledge of the space and its architecture. Thus, partitioning, as currently known, is somewhat cumbersome and cannot be easily and widely implemented in image based occupancy detection solutions.

### SUMMARY

Embodiments of the invention provide a method and system for analyzing occupancy in a space based on computer vision. In embodiments of the invention specific regions of the space may be identified to enhance analysis of the occupancy in the space. Specific regions of the space may be automatically identified based on image analysis, with no need for prior knowledge of the space and with no need for the images to be reviewed by a human operator, thereby ensuring privacy for occupants in the space.

A method for analyzing occupancy in a space, according to one embodiment of the invention includes identifying a region of interest (ROI) in the space based on image analysis of a first set of images of the space, detecting occupancy in the space based on image analysis of a second set of images of the space and producing or outputting a first output when occupancy is detected in the region of interest and a second output when occupancy is detected in the space outside the region of interest. The first and second outputs may be used in analyzing occupancy in the space.

In one embodiment analysis of occupancy may be used to control a device.

### BRIEF DESCRIPTION OF THE DRAWINGS

The invention will now be described in relation to certain examples and embodiments with reference to the following illustrative drawing figures so that it may be more fully understood. In the drawings:

FIGS. 1A and 1B are schematic illustrations of systems according to embodiments of the invention;

FIG. 2A is a schematic illustration of a method for occupancy analysis, according to one embodiment of the invention;

FIG. 2B is a schematic illustration of a method for controlling a device, according to an embodiment of the invention;

FIG. 3 schematically illustrates a method for determining an ROI based on detection of movement, according to an embodiment of the invention;

FIG. 4 schematically illustrates a method for determining a border of an ROI, according to an embodiment of the invention;

FIG. 5 schematically illustrates a method for determining an ROI based on detection of a movement having specific characteristics, according to an embodiment of the invention;

FIG. 6 schematically illustrates a method for analyzing occupancy in a space, according to an embodiment of the invention; and

FIGS. 7A and B schematically illustrate methods for occupancy analysis based on identifying an occupant, according to embodiments of the invention.

### DETAILED DESCRIPTION

Embodiments of the invention provide a method and system for analyzing occupancy in the space. The space may be an area in-doors or out-doors.

“Determining occupancy” or “detecting occupancy” as used herein may include detecting one or more occupant and/or monitoring one or more occupants throughout the space e.g., counting occupants, tracking occupants, determining occupants' location in a space, determining the direction of movement of occupants in the space, determining where the occupant is looking, etc.

“Analyzing occupancy” is used to describe a higher understanding of the situation of the occupants in the space; analysis of the determined or detected occupancy, e.g., the meaning or consequence of the location or number or direction of movement of occupants in the space, as will be exemplified herein.

“Occupant” may refer to any type of predefined occupant such as a human and/or animal occupant or an object (such as a vehicle or other object).

In one embodiment of the invention one or more specific regions in an imaged space (also referred to as regions of interest) may be detected based on detection of a visual cue in one or more images. Occupancy may be analyzed based on the detection of these specific regions.

In one embodiment of the invention one or more specific regions in the space (also referred to as regions of interest) may be identified based on image analysis of a first set of images of the space (a set of images may include one or more images). In one embodiment, the region of interest is identified based on a visual cue in the image(s).

Occupancy in the space may then be determined based on image analysis of a second set of images of the space, typically a set of images subsequent to the first set of images.

Different types of outputs may be output based on where in the space occupancy is detected. For example, when occupancy is detected in the region of interest a first type of output may be produced (e.g., no signal or a first signal may be generated) whereas when occupancy is detected in the space outside the region of interest, a second type of output may be produced (e.g., a second signal or no signal may be generated). If the first type of output includes a signal generated when occupancy is detected in the region of interest then a second type of output may include no signal and vice versa.

Occupancy in the space may be analyzed based on these two different outputs and a result of the analysis may be output to an operator, for example, by controlling a monitor viewed by the operator.

In one example, a specific room in a building (e.g., a museum or a factory) may be off limits to visitors. The building management may provide a visual cue, such as placing a sheet of a certain color or texture on the floor of the room or place an “off-limits” sign in the room, etc. The room, which is part of a space monitored by one or more imagers, may be identified as a region of interest based on the visual cue which will appear in one or more images of the space which includes the room. Thus, if an occupant is subsequently detected in that room a signal may be generated which may cause an alarm to be sounded, whereas, if an occupant is detected outside that room no signal is generated or a signal may be generated which will not trigger an alarm.

In another example, a building management is interested in occupancy in rooms but not in corridors outside of rooms. According to one embodiment a corridor often passed through by occupants may be identified as a region of interest based on the frequent and similar movement of occupants passing through the corridor. The frequent and typical movement of occupants through the corridor may be detected in images that include the corridor and this detection may be used by a system as a visual cue to identify the corridor as a region of interest. Once the corridor is identified as a region of interest, occupants or movement detected in the corridor in subsequent images may be ignored whereas occupants or movement detected in rooms may imply occupancy.

In the following description, various aspects of the present invention will be described. For purposes of explanation, specific configurations and details are set forth in order to provide a thorough understanding of the present invention. However, it will also be apparent to one skilled in the art that the present invention may be practiced without the specific details presented herein. Furthermore, well known features may be omitted or simplified in order not to obscure the present invention.

Unless specifically stated otherwise, as apparent from the following discussions, it is appreciated that throughout the specification discussions utilizing terms such as “analyzing”, “processing,” “computing,” “calculating,” “determining,” “detecting”, “identifying” or the like, refer to the action and/or processes of a computer or computing system, or similar electronic computing device, that manipulates and/or transforms data represented as physical, such as electronic, quantities within the computing system's registers and/or memories into other data similarly represented as physical quantities within the computing system's memories, registers or other such information storage, transmission or display devices.

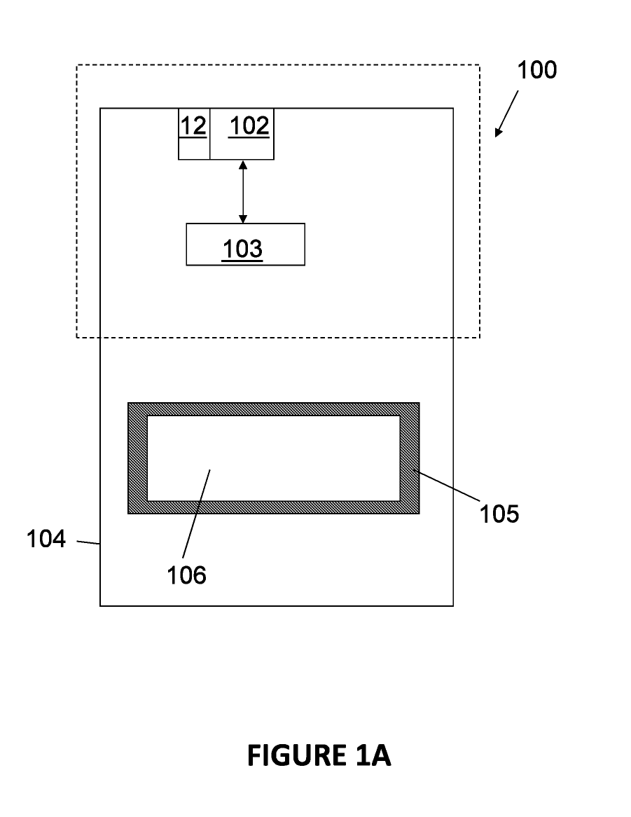

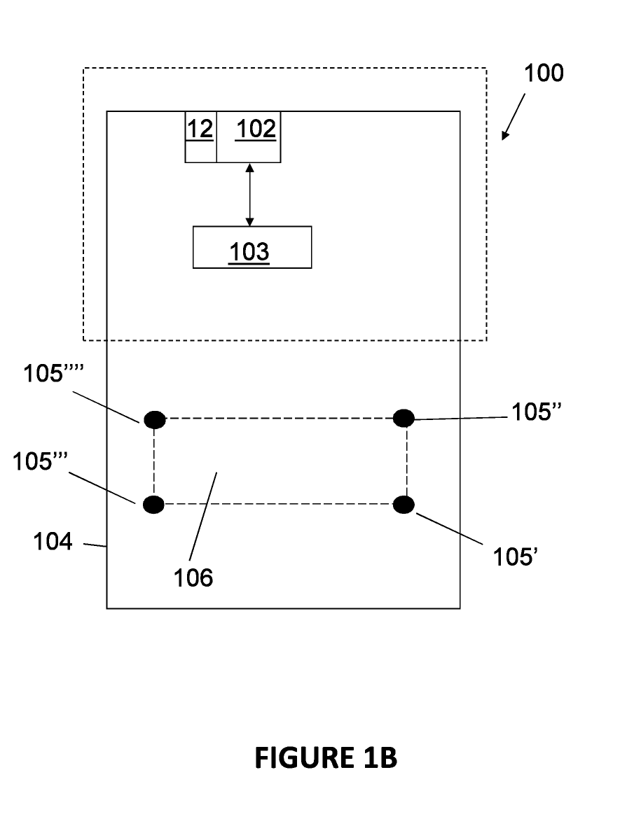

Examples of systems operable according to embodiments of the invention are schematically illustrated in FIGS. 1A and 1B.

In one embodiment the system 100 may include an image sensor 103 that can obtain images of the space 104. The image sensor 103 may be associated with a processor 102 and a memory 12. Processor 102 runs algorithms and processes to identify a region of interest in the space and to detect occupancy in the space based on image analysis, and to produce different outputs when occupancy is detected in the region of interest and when occupancy is detected in the space outside the region of interest. In one embodiment processor 102 produces a first output when occupancy is detected in the region of interest and a second output when occupancy is detected in the space outside the region of interest.

The processor 102 may be in wired or wireless communication with devices and other processors. For example, a signal generated by processor 102 may activate a process within the processor 102 or may be transmitted to another processor or device to activate a process at the other processor or device.

In one embodiment a device may be controlled based on the first and second outputs. For example a device may include an alarm which is activated based on the first output or on the second output or based on both outputs. In other embodiments the device may include electronic devices such as lighting and HVAC (heating, ventilating, and air conditioning) devices or other environment comfort devices which may be controlled, such as activated or modulated, based on the first output or on the second output or based on both outputs. In some embodiments the device includes a processor to analyze occupancy in the space based on the first and second outputs. For example, a device may include a monitor or screen to display data about the space based on the analysis of occupancy. In another example the device may include a counter to count occupants in the space. The counter may be part of processor 102 or may be part of another processor that accepts output, such as a signal, from processor 102.

Processor 102 may include, for example, one or more processors and may be a central processing unit (CPU), a digital signal processor (DSP), a microprocessor, a controller, a chip, a microchip, an integrated circuit (IC), or any other suitable multi-purpose or specific processor or controller.

Memory unit(s) 12 may include, for example, a random access memory (RAM), a dynamic RAM (DRAM), a flash memory, a volatile memory, a non-volatile memory, a cache memory, a buffer, a short term memory unit, a long term memory unit, or other suitable memory units or storage units.

Images obtained by the image sensor 103 are analyzed by a processor, e.g., processor 102. For example, image/video signal processing algorithms and/or shape detection algorithms and/or machine learning processes may be run by processor 102 and/or by another processor. According to some embodiments images may be stored in memory 12.

In one embodiment the processor 102 may include a detector to detect a shape of an occupant or of a visual cue in images of the space. In some embodiments further detailed below, the processor 102 may include a detector to identify and detect a predefined occupant.

In one embodiment an area or specific region 106 within space 104 is identified by processor 102 based on image analysis of images (one or more images) obtained by image sensor 103. Region 106 may include one or more visual cues (e.g., cue 105 in FIG. 1A and cues 105′, 105″, 105′″ and 105″″ in FIG. 1B) which can be identified by the processor 102. For example, a visual cue, such as a sign or other object in the region 106, may be identified in one or more images of the space 104 using image analysis processes.

In another embodiment, the visual cue includes a moving object or objects. For example, movement of occupants in a certain region of the space may be a visual cue for the processor 102 to identify the region in which occupants are moving as a region of interest. In another example a specific pattern of movement (movement of occupants or other predefined movement) may be a visual cue.

The borders of region 106 may be defined based on or in relation to the visual cue. In the example in FIG. 1A the visual cue 105 is in the shape and size of the desired border, however, in other embodiment the borders of region 106 may be predefined in relation to the visual cue. For example, the borders of region 106 may be determined as being a certain distance from the center of the visual cue 105. In the example in FIG. 1B, the borders of the region 106 may be determined based on the polygon created from cues 105′, 105″, 105′″ and 105″″).

The visual cue 105 or 105′, 105″, 105′″ and 105″″ may be identified by the processor 102 based on image analysis methods, such as color detection, shape detection and motion detection or based on a combination of these and/or other computer vision methods. For example, shape detection/recognition algorithms may include an algorithm which calculates features in a Viola-Jones object detection framework. In another example, the processor 102 may run a machine learning process. For example, a machine learning process may run a set of algorithms that use multiple processing layers on an image to identify desired image features (image features may include any information obtainable from an image, e.g., the existence of objects, such as occupants or visual cues, or parts of objects or visual cues, their location, their type and more). Each processing layer receives input from the layer below and produces output that is given to the layer above, until the highest layer produces the desired image features. Based on identification of the desired image features an object such as an occupant or visual cue may be identified. Motion in images may be identified similarly using a machine learning process.

In one embodiment the image sensor 103 is designed to obtain a top view of a space. For example, the image sensor 103 may be located on a ceiling of space 104 to obtain a top view of the space or of part of the space 104. Space 104 may include an in-door or out-door area.

Processor 102 may run processes to enable identification of occupants, such as humans, from a top view, e.g., by using rotation invariant features to identify a shape of a person or by using learning examples for a machine learning process including images of top views of people or other types of occupants or visual cues.

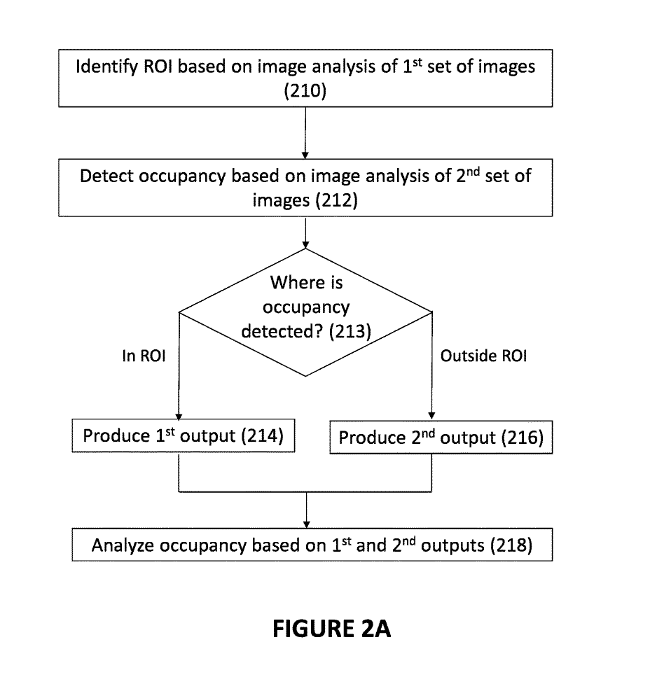

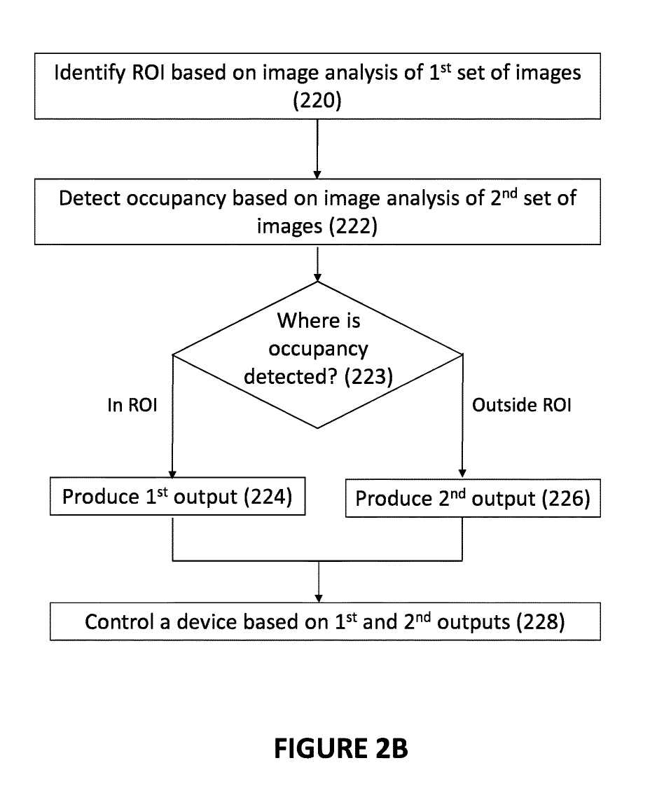

In one embodiment, which is schematically illustrated in FIG. 2A, a method for analyzing occupancy in a space includes identifying a region of interest in the space based on image analysis of a first set of images (which may include one or more images) of the space (210). Occupancy in the space is then detected based on image analysis of a second set of images of the space (212). The second set of images may include one or more images. The second set of images is typically a set of images subsequent to the images of the first set and in some embodiments may be referred to as a set of subsequent images.

If occupancy is detected in the region of interest (213) a first output is produced (214) and if occupancy is detected in the space outside the region of interest (213) then a second output is produced (216). The first and second outputs (alone or in combination) may be used to analyze occupancy in the space (218).

In some embodiments the analysis of occupancy in the space may be used to control a device, such as a monitor or screen, an alarm device, environment comfort devices or other devices or processors.

In some embodiments, one example of which is schematically illustrated in FIG. 2B, the first and second outputs are used to control a device such as a monitor or screen, an alarm device, environment comfort devices or other devices or processors.

In one embodiment a method for controlling a device includes identifying a region of interest in the space based on image analysis of a first set of images (which may include one or more images) of the space (220). Occupancy in the space is then detected based on image analysis of a second, typically subsequent set of images of the space (222).

If occupancy is detected in the region of interest (223) a first output is produced (224) and if occupancy is detected in the space outside the region of interest (223) then a second output is produced (226). The first and second outputs may be used to control a device (228).

The first and/or second outputs may include one or more signals or no signal however, the first output is typically a different type of output than the second output type. Thus, for example, if the first output includes no signal then the second output typically includes a signal and vice versa. If the first output includes a certain signal then the second output typically includes a different signal. Thus, for example, the first output may be ignored and the second output may be used to control a device or vice versa, the first output may be used to control a device whereas the second output may be ignored. Alternatively, the first output or the second output or a combination of the first and second outputs may be used to control the device.

The region of interest (e.g., region 106 in FIGS. 1A and 1B) may be identified based on image analysis of the first set of images. For example, image analysis may include applying color detection algorithms and/or shape detection or recognition algorithms and/or motion detection algorithms and/or any other appropriate image analysis methods or combination of methods. In one example machine learning techniques (e.g., as described above) are used to identify the region of interest in one or more images.

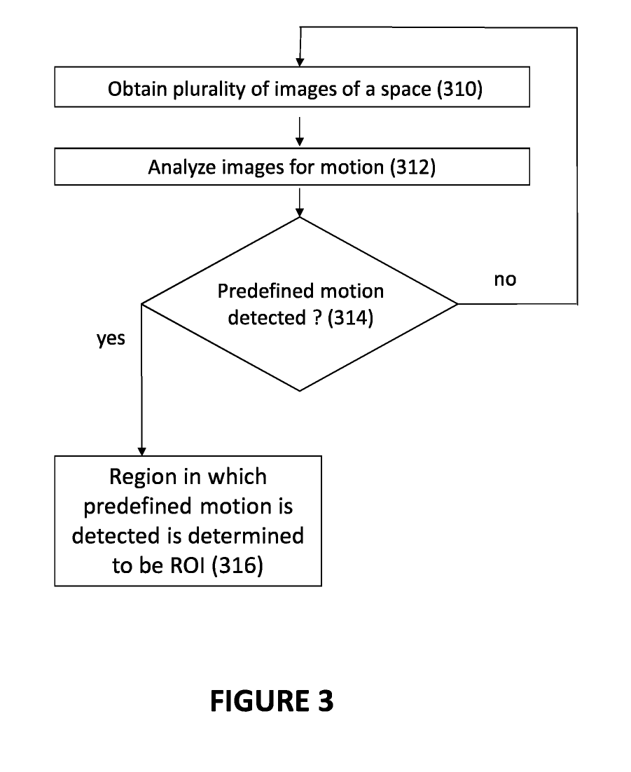

In one embodiment, which is schematically illustrated in FIG. 3, the region of interest is defined by motion.

In this embodiment a method for analyzing occupancy in a space includes obtaining a plurality of images of the space (310). The images are analyzed for motion (312) and if a predefined motion is detected (314), the region in which the predefined motion is detected is determined to be a region of interest (316). If the predefined motion is not detected another set of images is then analyzed for motion.

The borders of the ROI may be defined in relation to the location of the detected motion. For example, if the detected motion includes a blob occupying certain pixels, the borders of the region of interest may be determined to be the outline of the blob or in a distance of a certain amount of pixels from the perimeter of the blob. Thus, the borders of the region of interest may be dynamic and may change according to changes in the visual cue (e.g., changes in the size or shape of a blob).

In one embodiment a visual cue is detected in at least one image from a first set of images. The visual cue may be a static feature in the image (such as a non-moving object in the image) or a dynamic feature, such as a moving object or an object or blob which changes size, shape and/or other characteristics over time.

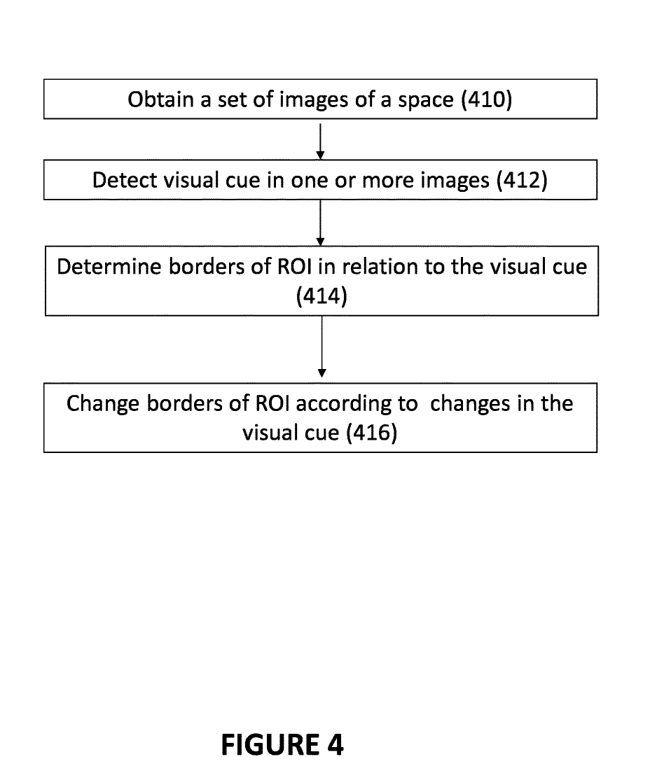

In one embodiment, which is schematically illustrated in FIG. 4, the method may include obtaining a set of images (one or more images) of the space (410) and detecting a visual cue in one or more images from the set of images (412). Borders of a region of interest are determined in relation to the visual cue (414). For example, borders of a region of interest may be determined to be at a certain distance or radius from a point in the visual cue (e.g., the center of the visual cue).

In one embodiment the borders are dynamic and may be changed according to changes in the visual cue (416). Thus, borders of a region of interest may be different at different time points.

In some embodiments the borders of the region may be determined based on a summation or average or other function of several borders determined in different images and at different time points. Thus, in one embodiment, a first border of a region of interest is determined in a first image (or plurality of images) and a second border of the region of interest is determined in a second image (or plurality of images) and a final border is determined by combining the first and second borders.

A predefined motion may include motion having certain, typically predefined characteristics. For example, a motion may be characteristic of a human gait or of the glide of a vehicle. Motion may be characteristic of a crowd. Motion may have a recurring pattern, etc. In some embodiments motion identified as persistent motion (e.g., having a recurring pattern) may provide a visual cue to identify the region in which the persistent motion was detected, as a region of interest. For example, motion created in an image by a fan or light source such as a TV or neon light may be detected and the regions of the fan or light source may be determined to be regions of interest. According to embodiments of the invention, further detailed below, movement detected in subsequent images in these regions of interest are ignored.

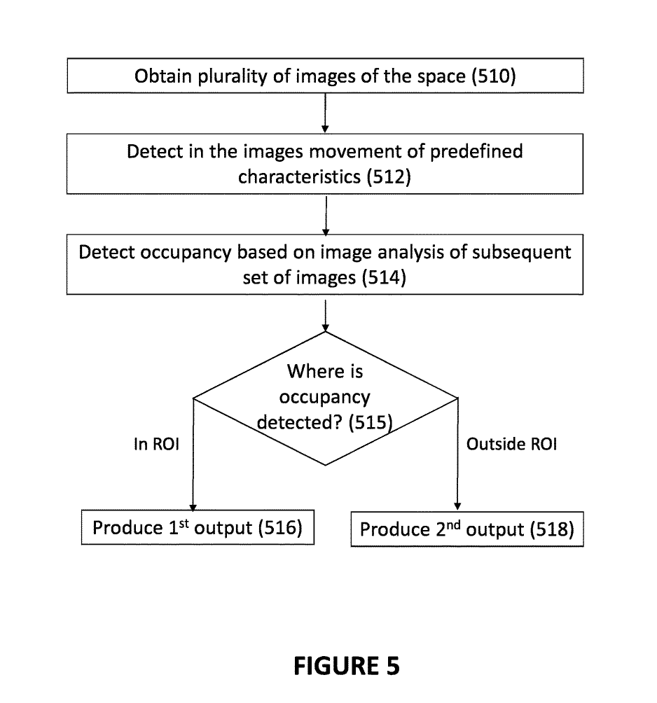

Thus, if for example, a region of interest is predefined as a region in which motion characteristic of a walking human occupant is detected, then the method, one example of which is schematic illustrated in FIG. 5, may include obtaining a plurality of images of the space (510) and detecting in the images a movement of predetermined characteristics (512), e.g., movement characteristic of a walking human.

In one example the movement characteristic of a walking human may include detecting an occupant in an image or images of the space and tracking the occupant in a first set of images of the space. A region of interest may be identified based on the tracking of the occupant. Namely, the area in which the occupant is detected throughout images of the space may be identified as a region of interest. Other methods for detecting movement characteristic of a human may be used, such as identifying movement of a certain shape, size, speed etc.

Occupancy in the space is then detected based on image analysis of a set of subsequent images (which may include one or more images) of the space (514). If occupancy is detected in the region of interest (515) a first output is produced (516) and if occupancy is detected in the space outside the region of interest (515) then a second output is produced (518). The first and/or second outputs may be used to analyze occupancy in the space and/or to control a device, such as described above.

According to embodiments of the invention detecting occupancy in the space includes detecting at least one occupant in an image from the set of subsequent images. Occupancy can be detected based on color detection, shape detection, motion detection or based on a combination of these and/or other image analysis techniques. In some embodiments detecting occupancy in the space can be done using machine learning techniques. Thus, for example, an occupant may be detected in images of a space based on detection of a shape of an occupant, for example by applying shape detection algorithms and/or machine learning techniques.

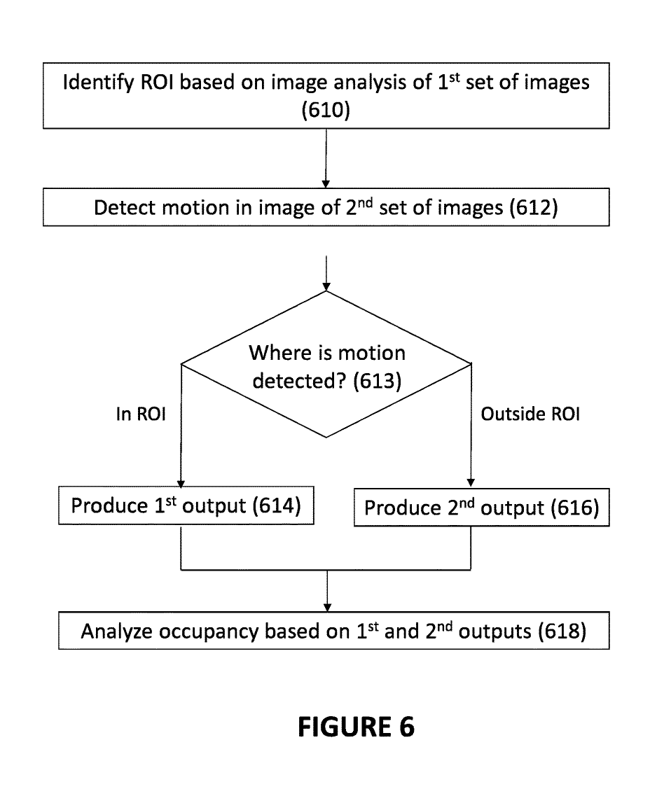

In one embodiment which is schematically illustrated in FIG. 6, occupancy is detected based on motion detection. Thus, in one embodiment the method includes identifying a region of interest in the space based on image analysis of a first set of images (which may include one or more images) of the space (610). Motion is then detected in a second set of images, typically subsequent images of the space (612). If the motion is detected in the region of interest (613) a first output is produced (614) and if the motion is detected in the space outside the region of interest (613) then a second output is produced (616). The first and second outputs (alone or in combination) may be used to analyze occupancy in the space (618).

In one example, the region of interest is identified based on detection of persistent motion (e.g., made by a fan or light source, as described above). If motion is detected in subsequent images in the region of interest the first output may include no signal but if motion is detected in subsequent images in the space outside the region of interest then the second output includes a signal indicative of occupancy. Thus, in one embodiment, motion detected in a region of persistent motion can be ignored when analyzing occupancy in the space.

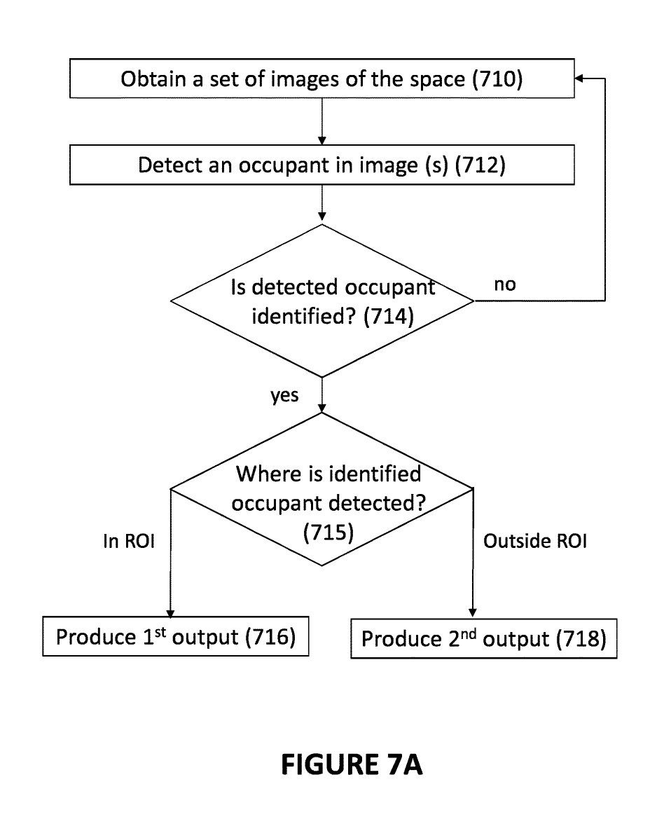

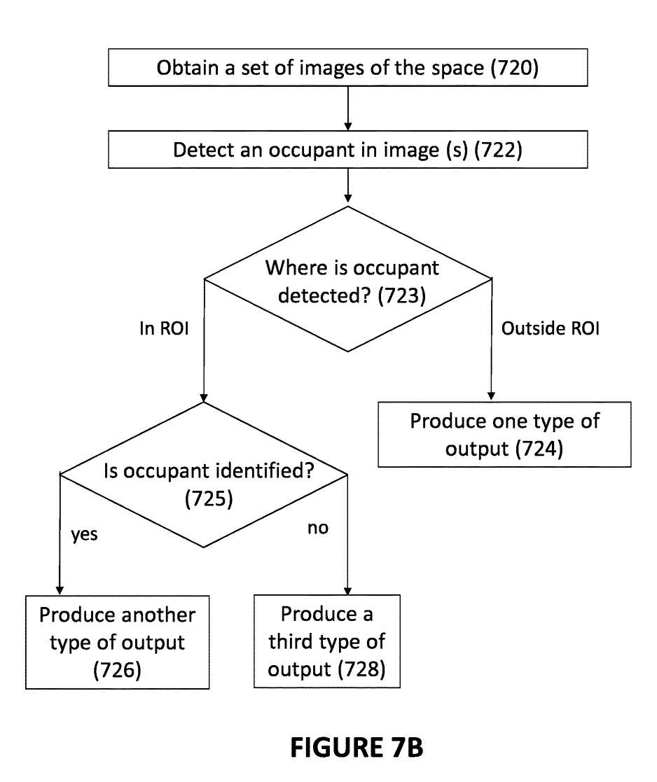

In one embodiment, an example of which is schematically illustrated in FIG. 7A, detecting occupancy in the space includes identifying a predefined occupant in the space.

In one example the method may include obtaining a set of images (one or more images) of the space (710), detecting an occupant in an image or images of the space (712) and identifying the occupant (714). If the occupant is not identified then another set of images may be scanned.

The occupant may be identified from the images by using, for example, face detection algorithms and may then be determined to be a predefined occupant by comparing the face of the occupant to a database of faces with known identities. Alternatively, an occupant may be identified based on an ID tag or other identifying signal from the occupant itself and connecting the identifying signal with an occupant detected in the images. The identity of the occupant may then be compared to a list of predefined occupants. In other embodiments occupants are identified based on what they are wearing (e.g., certain colored articles of clothing or the presence or absence of a particular article of clothing or other wearable or attachable marker carried by the occupant). Other known methods for identifying occupants may be used.

If an identified occupant is detected in a region of interest (715) then a first output is produced (716). However, if the identified occupant is detected in the space outside the region of interest, a second output is produced (718).

In an alternative embodiment detecting occupancy in the space includes identifying a predefined occupant in the space and producing different outputs when the identified occupant is detected in the region of interest and when an unidentified occupant is detected in the region of interest. In this embodiment an alarm or other signal may be produced dependent on the occupant detected in the ROI.

In the embodiment exemplified in FIG. 7B the method includes obtaining a set of images (one or more images) of the space (720) and detecting an occupant in an image or images of the space (722). Based on where occupant is detected (723) either a signal is produced or a process for identifying the occupant is initiated. If the occupant is detected outside an ROI then one type of signal is produced (724). If the occupant is detected within the borders of the ROI then if the occupant is identified (725) another type of signal may be produced (726) however if the occupant in the ROI is unidentified (725) then a third type of signal may be produced (728).

Identification of the occupant may be initiated at any suitable time point, not necessarily after an occupant is detected in an image or images of the space (722).

Thus, if an identified (or alternatively-unidentified) occupant is detected in a region of interest an alarm signal or other signal may be produced.

Embodiments of the invention may be used as a tool for analyzing occupancy in a space while maintaining privacy since the analysis is done automatically and internally on- site with no images being produced or sent for viewing to an operator. Embodiments of the invention may provide an understanding of the distribution of occupants in the space, for example, and may be advantageously used in security and other home and building applications.

1. A method for analyzing occupancy in a space, the method comprising:
identifying a region of interest in the space based on image analysis of a first set of images of the space;
detecting occupancy in the space based on image analysis of a second set of images of the space, the second set of images captured after the first set of images;
producing a first output when occupancy is detected in the region of interest and producing a second output when occupancy is detected in the space outside the region of interest.

2. The method of claim 1 wherein the image analysis comprises identifying a visual cue in one or more images from the first set of images.

3. The method of claim 2 comprising determining borders of the region of interest, the borders related to the visual cue in at least one image from the first set of images.

4. The method of claim 3 comprising changing the borders of the region of interest according to changes in the visual cue.

5. The method of claim 1 comprising identifying the region of interest based on either one of color detection, shape detection, motion detection or based on a combination thereof.

6. The method of claim 1 comprising identifying the region of interest based on tracking an occupant in the first set of images.

7. The method of claim 1 comprising detecting occupancy in the space based on either one of color detection, shape detection, motion detection or based on a combination thereof.

8. The method of claim 1 wherein detecting occupancy in the space comprises detecting at least one occupant in an image from the second set of subsequent images.

9. The method of claim 8 comprising detecting a shape of the at least one occupant.

10. The method of claim 1 wherein detecting occupancy in the space comprises identifying a predefined occupant in the space, the method comprising producing different outputs when the identified occupant is detected in the region of interest and when an unidentified occupant is detected in the region of interest.

11. The method of claim 1 comprising using one of the first output, the second output or a combination of the first and second output to control a device.

12. A method for analyzing occupancy in a space, the method comprising:
identifying a region of interest in the space based on image analysis of a first set of images of the space;
detecting motion in the space based on image analysis of a second set of images of the space, the second set of images captured after the first set of images;
producing a first output when the motion is detected in the region of interest and producing a second output when the motion is detected in the space outside the region of interest.

13. The method of claim 12 comprising identifying the region of interest based on detection of persistent motion in the first set of images.

14. The method of claim 12 wherein the first output comprises no signal and wherein the second output comprises a signal indicative of occupancy.

15. A system for determining occupancy in a space, the system comprising:
a processor configured to
identify a region of interest in the space based on a first set of images of the space,
detect occupancy in the space based on a second set of images of the space, the second set of images captured after the first set of images, and
produce a first output when occupancy is detected in the region of interest and a second output when occupancy is detected in the space outside the region of interest.

16. The system of claim 15 wherein the processor is to identify a region of interest in the space based on detection of a visual cue in at least one image from the first set of images of the space.

17. The system of claim 15 comprising a device in communication with the processor, the device configured to be controlled based on one of the first output, the second output or a combination of the first and second output.

18. The system of claim 17 wherein the device comprises an alarm.

19. The system of claim 17 wherein the device comprises an environment comfort device.

20. The system of claim 15 wherein the processor comprises a detector to detect a shape of an occupant in images of the space.
